(19) United States
(12) Patent Application Publication
(10) Pub. No.: US 2010/0298053 A1
(43) Pub. Date: Nov. 25, 2010

(54) DEVICE FOR ENHANCING OPERATION OF A GAME CONTROLLER AND METHOD OF USING THE SAME

(75) Inventor: David Kotkin, Miami, FL (US)

Correspondence Address: LERNER GREENBERG STEMER LLP, P O BOX 2480, HOLLYWOOD, FL, 33022-2480, US

(73) Assignee: ICONTROL ENTERPRISES, LLC, Monroe, NY (US)

(21) Appl. No.: 12/782,089

(22) Filed: May 18, 2010

Related U.S. Application Data
(60) Provisional application No. 61/179,551, filed on May 19, 2009.
(60) Provisional application No. 61/306,211, filed on Feb. 19, 2010.

(51) Int. Cl. A63F 13/06

(52) U.S. Cl. 463/37

(57) ABSTRACT

A device for enhancing operation of a game controller is provided. The device includes at least one actuator cooperating with a game controller for adding functions to be controlled with parts of the hand other than the thumbs, such as the side or tip of the index finger, while using the thumbs for other functions. A skin is placed onto part or all of the controller for permitting additional functions to be carried out.

### CROSS-REFERENCE TO RELATED APPLICATIONS

The present application claims priority to: co-pending Provisional Patent Application No. 61/179,551, filed on May 19, 2009 and entitled “Device for Enhancing Operation of a Game Controller and Method of Using the Same” and co-pending Provisional Patent Application No. 61/306,211, filed on Feb. 19, 2010 and entitled “Game Controller”; those applications being incorporated herein, by reference, in their entireties.

### BACKGROUND OF THE INVENTION

1. Field of the Invention

The invention relates to a device for enhancing operation of a game controller and a method of using the same which allow the user of the device to manually control features of a game beyond those which are assigned to the usual buttons or keys without moving the user's hand from the usual position.

2. Description of the Related Art

Prior art game controllers have buttons or keys which are depressed or otherwise actuated to carry out various movements within the game, such as controlling movements of a character on a computer screen, television or dedicated game screen. However, the limitations of the human hand require the user to release some buttons or keys to actuate others. This detracts from the user's ability to play the game to the best of the user's ability and can also lead to debilitating repetitive use injuries or medical conditions, such as so-called “Play Station Palm” or “Blackberry Finger.”

Additionally, “skins” for covering video game controllers are known. For example, U.S. Patent Application Publication No. 2004/0164489 to Singer discloses a video game mask, including a thin pliable shell that conforms to the shape of a video game controller, which displays game instructions and/or static instructions. See also, for example, U.S. Patent Application Publication No. 2008/0122173 to Harris disclosing a form-fitting electronic game controller cover, U.S. Patent Application Publication No. 2007/0045951 to Robertson et al disclosing a video game mask and U.S. Pat. No. Des 521,567 to Svendsen et al., disclosing a cover for a game controller. However, known video game controller “skins” do not incorporate actuators that enhance the functionality of the controller. Rather, existing skins either overlay or pass-through the existing buttons and actuators on the controller, thus causing the buttons to be actuated in an identical manner as actuated without the skin.

What is needed is an accessory for a video game controller that integrates with an existing video game controller to provide enhanced functionality to the user. What is additionally needed is an accessory for a video game controller that reduces the strain on the hands of a user.

### BRIEF SUMMARY OF THE INVENTION

It is accordingly an object of the invention to provide a device for enhancing operation of a game controller and a method of using the same, which overcome the above-mentioned disadvantages of the heretofore-known devices and methods of this general type and which permit the user to control many more features of a game than would normally be possible while using the fingers of one hand.

With the foregoing and other objects in view there is provided, in accordance with the invention, a device for enhancing operation of a game controller, comprising at least one actuator cooperating with a game controller for adding functions to be controlled with parts of the hand other than the thumbs while using the thumbs for other functions.

With the objects of the invention in view, there is concomitantly provided a method for using a game controller, which comprises moving an actuator with parts of the hand other than the thumbs while using the thumbs for other functions.

Other features which are considered as characteristic for the invention are set forth in the appended claims.

Although the invention is illustrated and described herein as embodied in a device for enhancing operation of a game controller and a method of using the same, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1A is a front plan view of an existing game controller with which can be used with an accessory in accordance with the instant invention;

FIG. 1B is a front plan view of another existing game controller which can be used with an accessory in accordance with the instant invention;

FIG. 2 is a front plan view of one example of a video game controller encased in a skin according to one particular embodiment of the present invention;

FIG. 3 is a side plan view of a video game controller and skin in accordance with another particular embodiment of the present invention;

FIG. 4A is a front plan view of a video game controller encased in a skin according to a further embodiment of the present invention;

FIG. 4B is a side plan view of a motorized actuator useful with particular embodiments of the present invention;

FIG. 5 is an exploded perspective view of a skin in accordance with one particular embodiment of the present invention;

FIGS. 6A and 6B are, respectively, a front plan view and a rear plan view of the skin of FIG. 5;

FIGS. 6C and 6D are, respectively, a right side plan view and a left side plan cut-away view of the skin of FIG. 5;

FIGS. 6E and 6F are, respectively, a bottom end view and a top end view of the skin of FIG. 5;

FIG. 7 is a perspective view of a controller positioned for placement into a skin in accordance with one particular embodiment of the present invention; and

FIG. 8 is a perspective view of one particular embodiment of a stand useful in combination with a skin in accordance with the present invention.

### DETAILED DESCRIPTION OF THE INVENTION

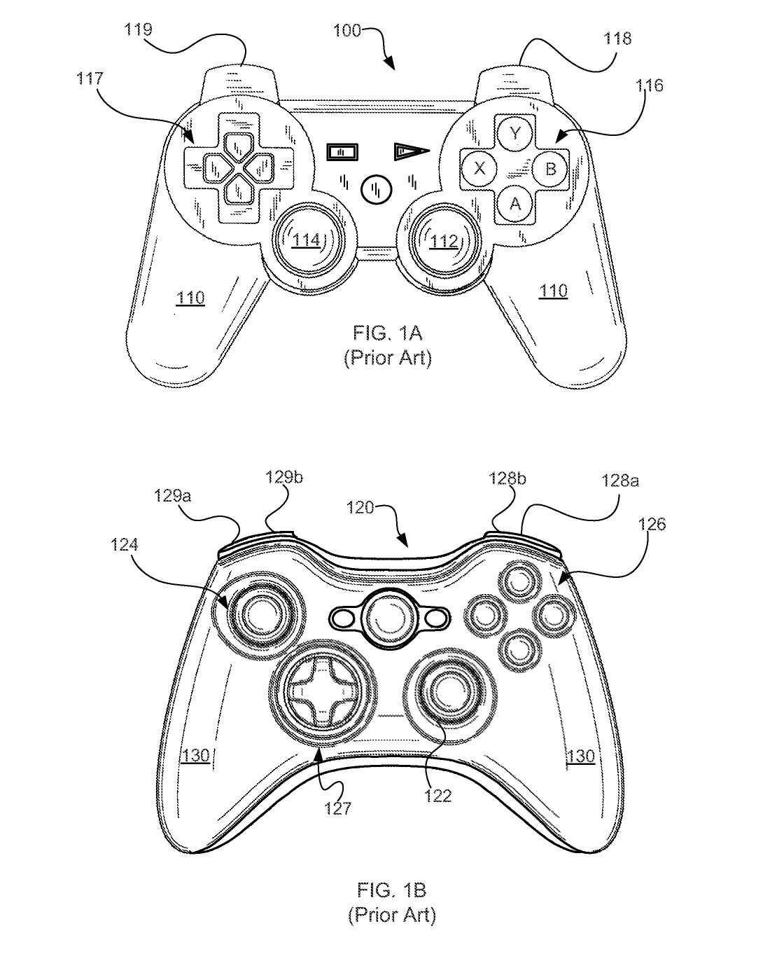

Referring now to FIGS. 1A and 1B, there are shown two video game controllers 100, 120 that are presently available on the market. More particularly,

FIG. 1A shows a front plan view of a video game controller for use with the PLAYSTATION 3, made by Sony Corp., while FIG. 1B shows a front plan view of a video game controller for use with an XBOX 360, made by Microsoft Corp. Although the invention will be discussed herein in connection with the video game controllers 100, 120, this is not meant to be limiting. Rather, it can be seen from the disclosure herein that the accessories of the instant invention can be adapted for use with controllers having other configurations and/or designed for other video game consoles without departing from the scope of the present invention.

Existing video game controllers 100, 120 include multiple control actuators representing different functions in different video games. In use, the video game controllers 100, 120 are conventionally held by the user by grasping the grips 110, 130 in the palm of the users hands such that the user's thumbs can access different actuators on the face of the controllers 100, 120. The user's hands are additionally positioned such that the tips of the index fingers are held adjacent to the trigger and/or bumper buttons 118, 119, 128a, 128b, 129a, 129b of the controllers 100, 120. Such existing controllers are arranged so that the majority of actuators are designed to be controlled by the user's thumbs. For example, on the controllers 100, 120, it is intended that the user's right thumb actuate, among other things, each of the four buttons 116, 126 (typically labeled “X”, “Y”, “A” and “B”) and the right-side thumb stick 112, 122. Additionally, with such existing controllers it is intended that the user's left thumb actuate a directional pad or D-pad 117, 127 and a left-side thumb stick 114, 124. When playing a game on the console, it is often required to remove a thumb from one actuator to use it to control another actuator. For example, a user directing an avatar through a video game using the right-side thumb stick 112, 122, must periodically release the right-side thumb stick 112, 122 and use the same thumb to operate one of the buttons 116, 126 to invoke the function controlled thereby.

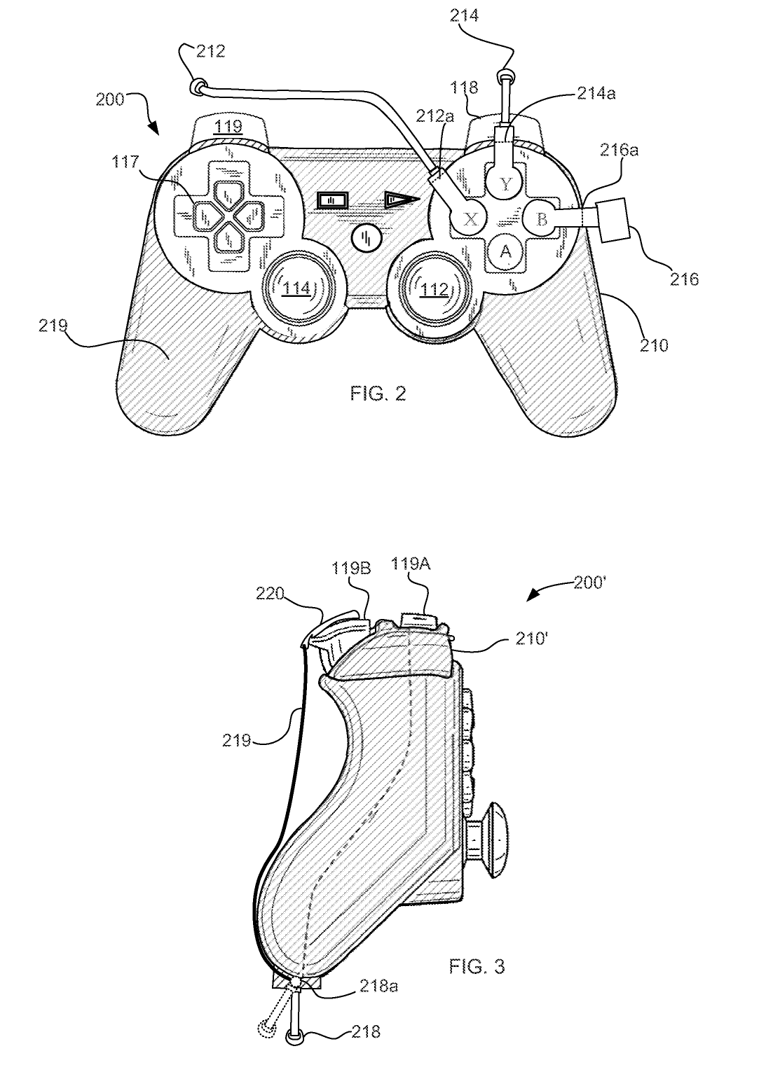

Referring now to the FIG. 2, there is shown one particular video game controller 200 having thereon a skin 210 in accordance with one particular embodiment of the present invention. In particular, a skin or shell 210 is placed onto part or all of the controller 200 for accommodating the additional functions according to the invention. Although shown and described in connection with the Playstation 3 controller 100 of FIG. 1A, it should be understood that the same principles of the invention can be easily adapted to other types of video game controllers, including the XBOX 360 controller 120 of FIG. 1B, without departing from the scope of the invention. The skin 210 overlays the outer housing of the controller 200 and is completely removable from the controller 200. For example, the skin 210 may be made from rubber or plastic, as desired. In one particular embodiment, the skin 210 is made of a flexible rubber material, such as neoprene. In another particular embodiment, the skin 210 is formed as a plastic shell that is molded to conform to the shape of the controller 200.

Additionally, the skin 210 has certain actuators attached thereto relative to various control buttons on the controller 200. As shown in FIG. 2, the skin includes the levers 212, 214, 216 overlaying the “X”, “Y” and “B” control buttons of the controller 200, respectively, particularly arranged for actuation by the tip or side of a finger, preferably the index fingers. Each of the levers 212, 214, 216 includes a plate portion that overlays the respective button “X”, “Y” and “B” and an arm portion extending from the plate portion. The body of each lever 212, 214, 216 are pivotally mounted to the skin 210 at a pivot point or hinge 212a, 214a, 216a, respectively. Hinges 212a, 214a, 216a are, preferably, spring-biased and can be secured to the skin 210 by any number of mechanisms, including being formed therewith and/or therethrough, being secured thereto by mechanical means, such as screws, rivots, plastic welds, permanent adhesive, etc. Alternately, if desired the hinges 212a, 214a, 216a can be secured to the skin by a less permanent mechanism, such as by a releasable adhesive tape, a strong hook and loop fastener, a preformed slide-in mounting bracket, etc., to permit the levers to be mounted to the skin, as desired.

Thus, the levers 212, 214, 216 are actuable by a user to actuate the buttons “X”, “Y”, “B”, as desired. Further, because of the alignment of the user's hands during play, the levers 212, 214 and 216 can be actuated by fingers other than the user's thumbs, thus permitting the use of the buttons “X”, “Y” and “B” without necessitating the removal of the user's thumbs from the thumb sticks 112, 114 and/or D-pad 117. This permits functions such as walking, running, jumping, switching weapons, shooting and zooming to be controlled by the “X”, “Y” and “B” buttons, while keeping the thumbs in place on the standard buttons or keys.

More particularly, during normal use, the controller 200 is gripped by the user such that the tips of the right and left index fingers are adjacent the buttons 118, 119, respectively, to enable use of the buttons 118, 119. As such, when using a skin 210 in accordance with the invention, the tips of the right and left index fingers of the user are positioned under the levers 214 and 212, respectively, while the lower portion of the index finger is disposed under the lever 216.of the skin. The levers 212, 214 and 216 are actuated using the sides of the index finger, without requiring using or moving the user's thumbs. Thus, the user need only lift a portion of an index finger a slight amount in order to lift the free end of the lever with the side of the index finger and, resultantly, the lever depress the respective button “X”, “Y” or “B”. A spring disposed under the pivot point can be used to return the lever to the normal, level position after it is released.

It is important to note that more or less levers than shown can be integrated with the skin 210 of the present invention. For example, for certain applications, it may be desirable to include less than all of the levers 212, 214 and 216 on the skin 210. Similarly, it may be desirable to provide even more levers for controlling even more functions of the controller 200. For example, referring now to FIG. 3, there is shown an embodiment of a controller 200′ including a skin 210′ having a further lever 218 that is provided instead of, or if desired, in addition to the levers 212, 214, 216 of FIG. 2. The embodiment of FIG. 3 shows a further mechanism for providing additional functionality using a part of the hand other than the user's thumb. In particular, a removable tape or self-adhering sheet 220 is attached to a trigger or button 119B (i.e., which can be the “L2” button on the Playstation 3 controller. A flexible cable or line 219 is connected between the sheet 220 and the lever 218. The line 219 is connected to the lever 218 by a linkage 218a. Operation of the lever 218 using the pinky or palm of the user, for example, adjusts the tension of the line 219 in accordance with a preference of the user. The line 219 runs under, or to the side of, the controller 200′. Applying pressure to the line 219, even lightly, with the palm of the user's hand will pull the trigger 119B. This permits the trigger 117a to be actuated without using a thumb, or even an index finger, of the user. Pivoting of the lever 218 about the linkage 218a adjusts the sensitivity of the trigger 119B (i.e., the level of pressure needed to actuate the trigger) to the player's preference. Thus, the control of the trigger 119B is highly adjustable for functions such as, for example, a zoom control function operable by the trigger 119B. A mere change of the user's grip will slightly pull the line 219 and, correspondingly, the trigger 119B.

Thus, the levers 212, 214, 216, 218, preferably secured to the skin 210 by the hinges 212a, 214a, 216a, 218a, are provided for actuation by parts of the hand other than the thumbs. These features make use of the fingers to provide a great playing advantage, while avoiding over-use injuries. If desired, the levers 212, 214, 216, 218 can be made from a plastically deformable material so as to be customizable by the user to fit the user's particular hand. Additionally, if desired the skin 210 can be made to include flashing LED lights that are activated by a sensor in response to a sensed touch, a vibration or a rumble from the controller. Similarly, if desired, any or all of the levers 212, 214, 216 218 can be replaced by LED levers that light up when touched and/or otherwise actuated. Further, although shown in FIG. 2 as encompassing the entire controller, it is intended that the skin 210 can be made to cover less than the entire controller (i.e., only a part of the controller), if desired, without deviating from the spirit of the invention.

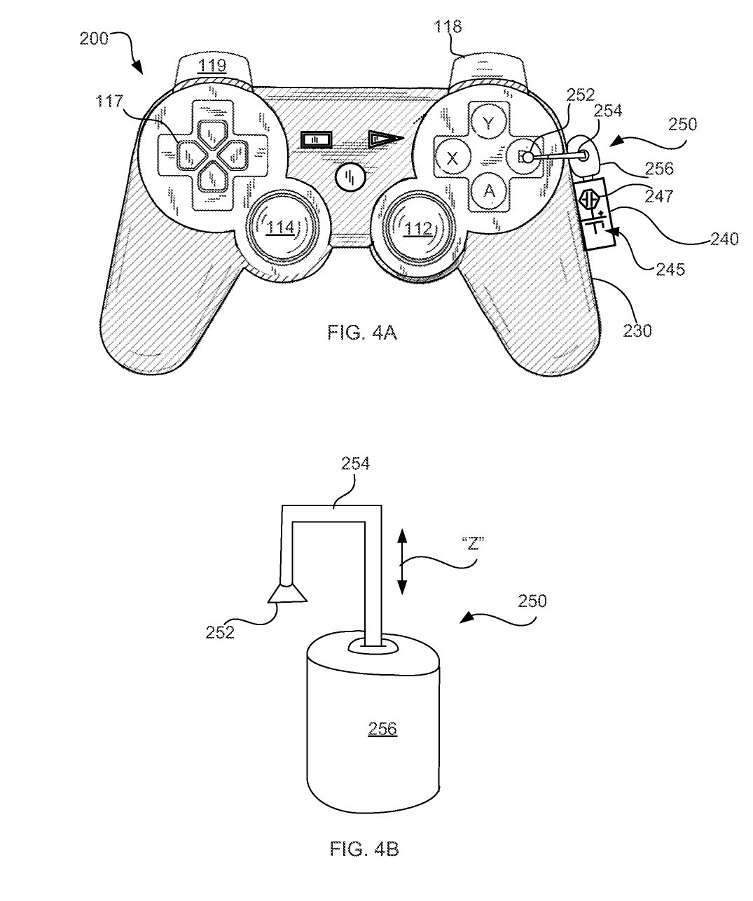

Referring now to FIGS. 4A and 4B, there is shown a video game controller 200 including a skin 230 in accordance with a further embodiment of the invention. More particularly, the skin 230 includes mounted thereon, a motorized actuator 250. The motorized actuator 250 includes a footpad 252 that is aligned with at least one of the buttons “X”, “Y”, “A” or “B”. In the embodiment illustrated in FIG. 4A, the footpad 252 initially rests just above the “B” button of the controller 200. The footpad 252 is mounted to a shaft 254, which is connected to the actuator of a motor 256. Actuation of the motor 256 pulls the shaft 254 downward, so as to engage the foot pad 252 with the button “B”. When turned off, the motor 256 releases the shaft 254, which returns to its initial position, thus removing the footpad 252 from contact with the “B” button of the controller 200. Thus, the motor works to move the footpad along a “Z” axis relative to the button “B”.

Actuation of the motor 256 is controlled by a signal representative of a sensed motion of the controller 200. More particularly, the skin 230 of the instant embodiment includes, secured thereto or therein, a compartment 240 including a motion sensor 247 powered by a battery 245. The motor 256 is driven according to a signal output from the motion sensor 247. For example, in one particular embodiment of the invention, the motor operates to press the button “B” with the footpad 252 when the sensor 247 detects that the controller 200 has been tilted up or down relative to a predefined plane. The button “B” is released by the motor when the sensor 247 detects that the controller 200 is again being held substantially parallel to the defined plane.

As an alternate to the configuration shown in FIG. 4A, note that the battery for the motorized trigger actuator can be inserted into a battery holder in the controller, which is interfaced with the sensor 247 and motor 256. Additionally, other buttons and/or triggers on the controller 200 can be actuated by a motorized actuator 250, as desired. Thus, the presently described embodiment provides a mechanism for engaging buttons based on a slight tilt of the controller 200, rather than requiring the user to actuate the button or trigger with a finger. Note that, if a plurality of motorized actuators 250 are used, the a controller (i.e., ASIC, microcontroller and/or microprocessor) can be included on the skin and can be programmed to actuate the buttons and/or triggered in various combinations in response to specific, predetermined stimuli. For example, tilting the controller in a particular direction at greater than a predetermined angle could actuate the motorized actuators to hit the buttons in a predetermined combination, for example, XX+YY, in order to deliver a predetermined function (e.g., “super punch”, etc). This, too, helps to reduce strain on the fingers of the user.

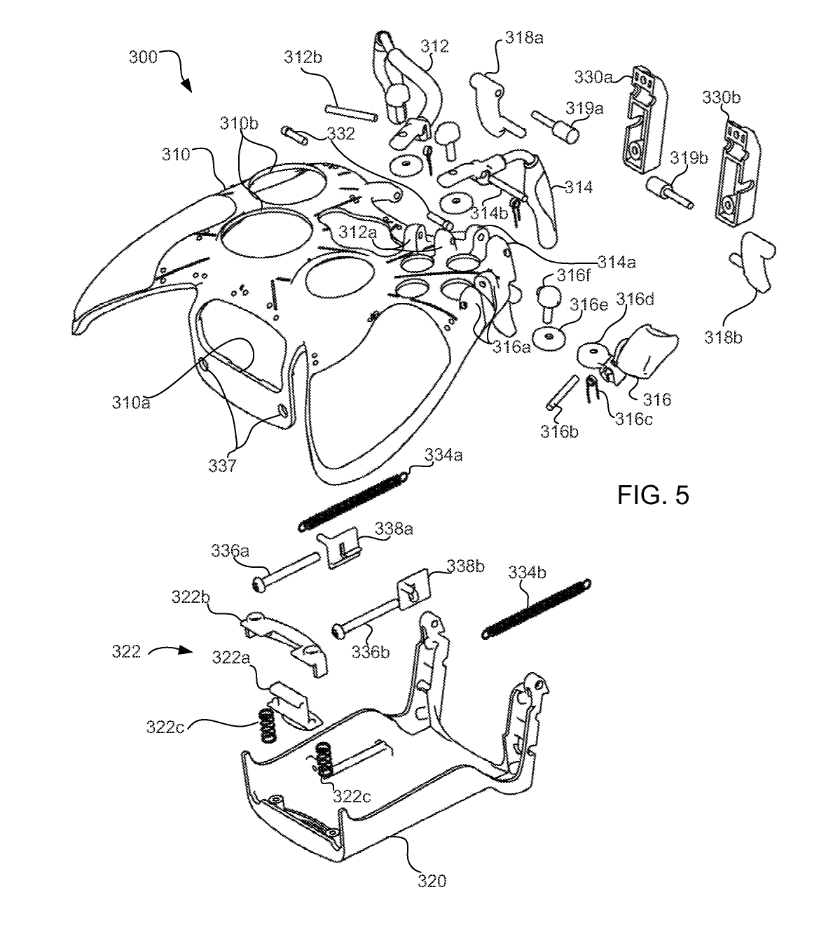

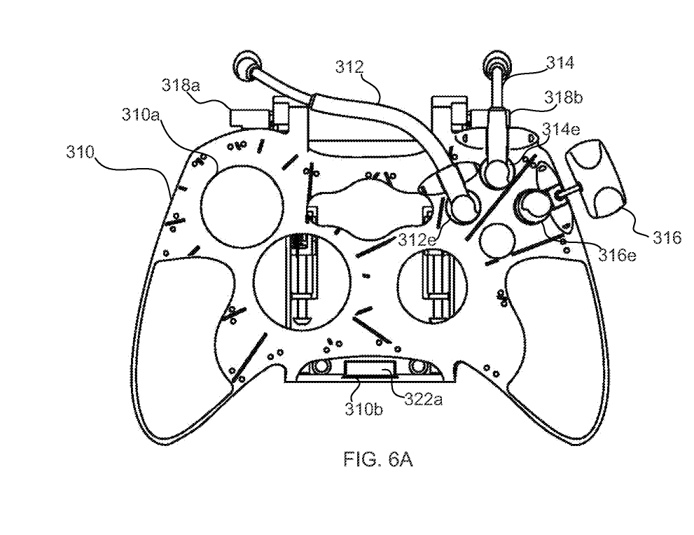

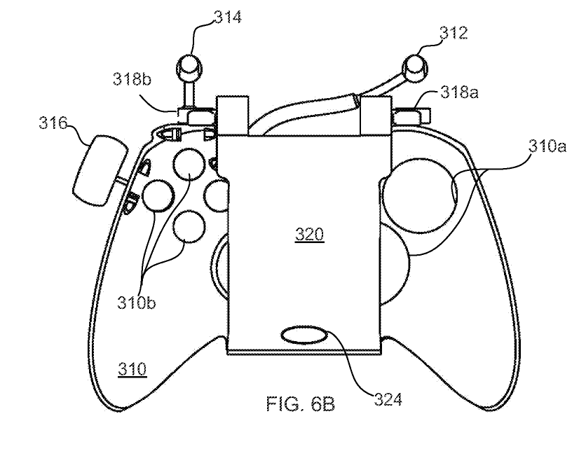

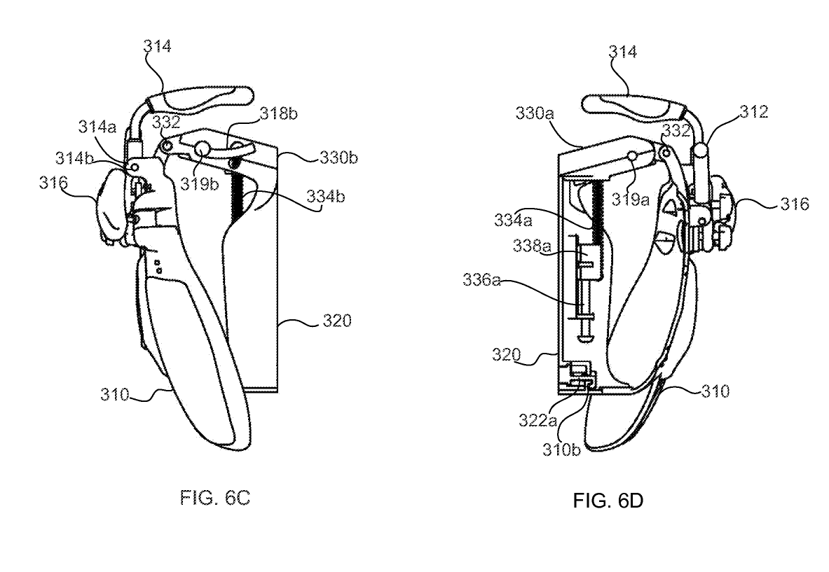

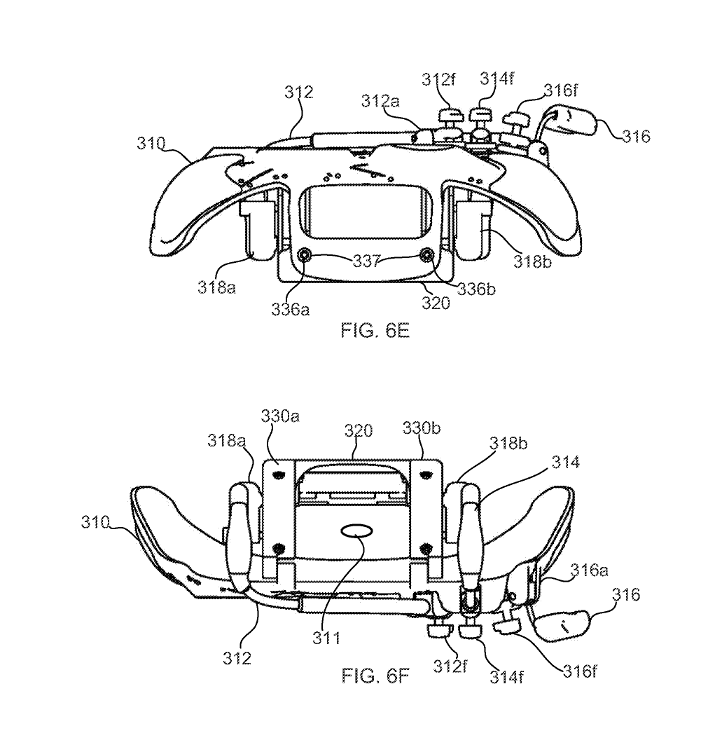

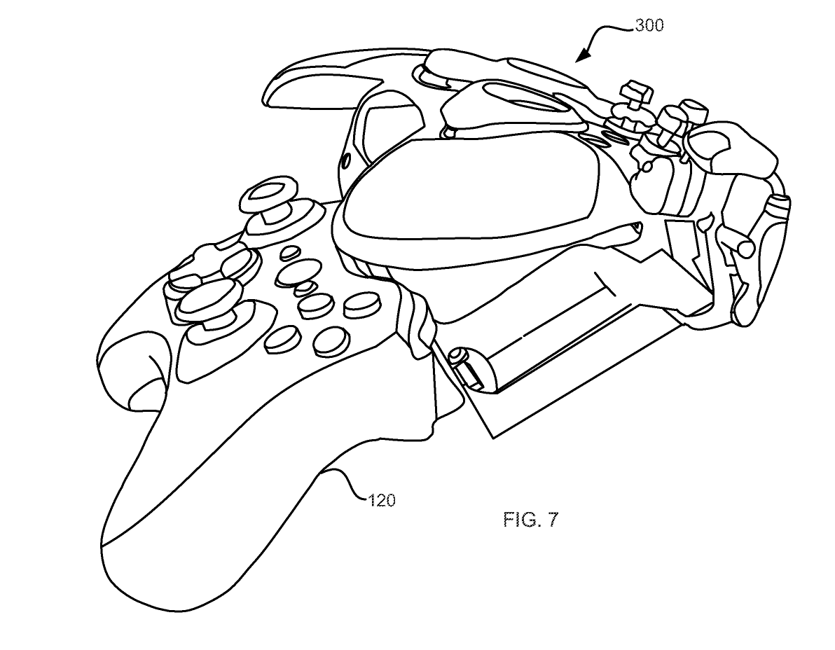

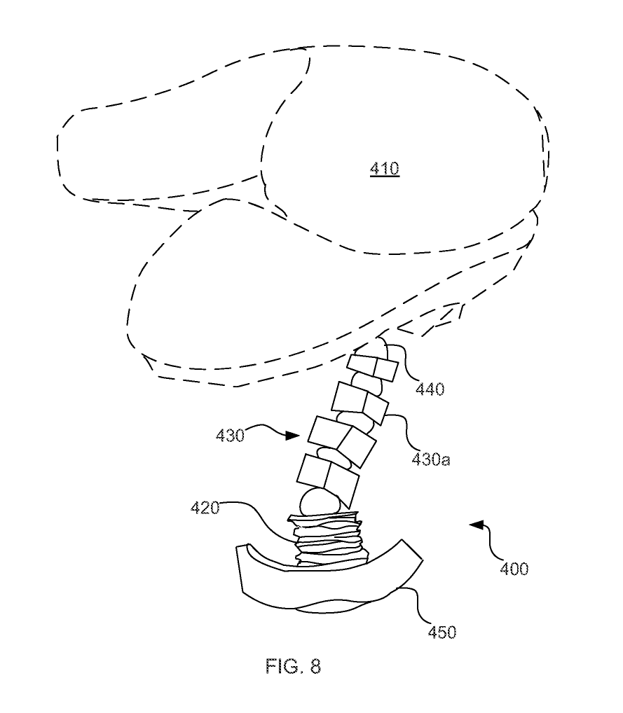

Referring now to FIGS. 5, 6A-6F and 7, there is shown a skin or shell 300 for a video game controller in accordance with another particular embodiment of the present invention. The skin 300 includes a top housing or face plate 310 that is formed or shaped to closely fit the front face of the outer housing of a particular video game controller, the underside of the hop housing 310 contacting the face of the video game controller. In the example shown in FIGS. 5, 6A-6F and 7, the top housing 310 is shaped to conform to the front face of an XBOX 360 controller 120. However, it should be understood that the front face 310 can be formed to fit other controllers. Additionally, in the instant embodiment the skin 300 is formed from a substantially rigid molded plastic. Alternately, the skin 300 can be made from a flexible material and/or a film, as desired. It is important to note that the “skin” of the present invention is not the outer housing or shell of the game controller, itself, but rather, the skin of the instant invention sits over the outer housing or shell of the game controller.

The front face of the top housing 310 includes a number of hinges or fulcrums 312a, 314a, 316a integrally formed thereon to act as fulcrums for the levers 312, 314, 316, respectively. Each of the levers 312, 314, 316 is secured to its respective fulcrum 312a, 314a, 316a using a pivot pin, such as the pivot pins 312b, 314b and 316b. Additionally, each lever 312, 314, 316 is spring biased by a spring, such as the torsion spring 316c, to return to an initial, open position when a pressure on the lever 312, 314, 316 is released. Further, the top housing 310 includes a plurality of openings therethrough, such as openings 310b, each opening 310b corresponding to a different feature on the face of the controller, such as a button, trigger, switch, grip, etc. Buttons such as the “A”, “B”, “X” and “Y” buttons 116, 126 of the controllers 100, 120 of FIGS. 1A and 1B protrude through openings 310b in the top housing 310.

Each of the levers 312, 314, 316 is aligned over one of the buttons “B”, “X” and “Y” of the controllers 100, 120. More particularly, each of the levers 312, 314, 316 includes a pad, such as pad 316e, that is mounted to an arm of the lever via a finger, such as finger 316d, by an adjustment screw, such as thumb screw 316f. For example, the pad 316e is attached to the lever 316 at the finger 316d via the screw 316f and overlies the “B” button of an underlying controller upon which the skin 200 is placed. The screw 316f can be adjusted to “fine-tune” the height of the pad 316e over the actual “B” button of the underlying controller, in order to set to a user's preferences the amount of lift of the lever 316 required to depress the button “B”. To assemble the pad, first the adjustment thumb screw 316f is installed through a tapped hole in the lever finger 316d, after which the screw pad 316e is snapped onto the threaded free end of the screw 316f, thus holding the pad 316e a distance over the “B” button defined by the adjustment screw 316f. The other levers 312, 314 include corresponding parts (i.e., pads 312b, 314b, screws 312f, 314f, etc.) that operate in a corresponding manner as described in connection with lever 316. Each of the levers 312, 314, 316 includes a flexible rod portion that can be bent to adapt to the hand of the user and/or to the user's preferences. Additionally, the stems at the free ends of the levers 312, 314, 316 can include overmold detail and pads for visual enhancement and/or comfort to the user.

In one particular embodiment of the invention, the levers 312, 314, 316 can be lighted, and/or, if desired, can be connected to a sensor, such as a mercury switch or accelerometer, to light when the controller contained within the skin 300 vibrates or when the lever 312, 314 or 316 is actuated. Optionally, a battery pack 311 can be included in a housing portion of the skin 300 to power such features of the invention. Note that the battery pack 311 can be located at other positions on the skin 300. For example, the battery could be part of one or more of the levers 312, 314, 316 of a motor assembly, if included. Additionally, if desired, in order to prevent the skin 300 from becoming top heavy, the battery pack 311 could be located in an out of the way position on the skin 300, including on the housing bottom, and would be connected to the elements needing power via a wire line.

A rear housing or housing bottom 320 is additionally provided, which mates with the top housing 310 to enclose a game controller therebetween. More particularly, the housing halves are pivotally connected together at one end using the hinge pins 332. In one particular embodiment of the invention, the hinge pins 332 are press fitted into the top housing 310 and rotate freely within the housing bottom 320. This rotatably secures the top and bottom housings and permits the two halves to be pivoted apart from one another in order to place the game controller therein. At the other end, the housing bottom includes a latching mechanism 322 that secures the free end of the housing bottom 320 to the free end of the top housing 310 upon closure of the shell 300. The latch 322 is a spring loaded latch including the latch 322a, the latch cover 322b and the compression springs 322c. The latch 322a is positioned to mate with a tongue 310a located on the underside of the top housing 310 when closed. Additionally, the latch 320 is biased closed by the compression springs 322c, which apply a force causing the latch to automatically lock when the top housing 310 and the housing bottom 320 are rotated into the closed position. A button 324 is provided on the housing bottom 320 to release the latch 320 (i.e., disengage the latch 322a from the tongue 310a) when pressed, in order to open the housing.

In the instant embodiment, the housing bottom 320 additionally acts as a pressure plate for operating left and right side triggers on the controller, much in the same way as is described in connection with the line 219 of FIG. 3. More particularly, the shell 300 includes left and right side triggers 318a and 318b for operating further trigger buttons located on the end faces of the video game controller housed in the shell 300. Left and right housing covers 330a, 330b, respectively, are provided to engage the pivoted end of the housing cover and to support left and right trigger levers 318a and 318b. In particular, an enlarged head portion of each hinge pin 319a, 319b is entrapped between a bracket of the housing bottom 320 and a respective one of the housing covers 330a, 330b, such that a smaller pin extends outwardly from a hole in the housing covers 330a, 330b. The smaller pin portion of each of the hinge pins 319a, 319b engages, and is permanently fixed to, a respective one of the trigger levers 318a, 318b.

Thus, when the housing is closed with a controller therein, applying a slight pressure to one of the left or right sides of the housing bottom 320, relative to the top housing 310 (i.e., thus “squeezing” the housing), will actuate a trigger button (such as L1, L2 or R1, R2) on the end face of the controller with the appropriate trigger lever 318a, 318b of the skin 300. Note that this occurs merely through squeezing the housing, and not by manipulation with a thumb or forefinger of the user.

A mechanism is additionally provided for adjusting the tension of the trigger buttons 318a, 318b. more particularly, the housing bottom 320 includes left and right tensioning mechanisms controlling the tension on the triggers 318a, 318b. Each tension mechanism includes a screw, a spring adjustment block and a spring. For example, the left side tensioning mechanism includes the left side spring 334a, screw 336a and adjustment block 338a, while the right hand side tensioning mechanism includes the right side spring 334b, screw 336b and adjustment block 338b. When assembled, each spring 334a, 334b is connected between a hook on one of the spring adjustment blocks 338a, 338b and a post on a respective one of the trigger levers 318a, 318b. The screws 336a, 336b engage the adjustment blocks 338a, 338b, such that when one of the screws 336a, 336b is turned, the corresponding spring adjustment block 338a, 338b, translates forward or back (based on screw turning direction) in the housing bottom 320 to change the amount of extension of the spring and adjust the amount of preload force on the trigger lever 318a or 318b.

Holes 337 are provided in an end face of the housing bottom 320 to provide access to the heads of the screws 336a, 336b when the housing is closed, to permit a user to set the tension of the triggers 318a, 318b to the user's own preferences, using a screw driver, Allen wrench, key or other tool. Thus, each screw 336a, 336b adjusts the amount of spring force on the corresponding trigger 318a, 318b, and the springs 334a, 334b pull back on a corresponding trigger lever 318a, 318b to assist in the trigger pull when the users grip “squeezes” a respective side of the housing bottom 320.

In another particular embodiment of the invention, a skin made in accordance with the teachings of the instant invention can additionally be adapted for use with a snap-on stand. Referring, more particularly, to FIG. 7, there is shown a stand 400 that can be snapped onto a skin accessory for a game controller 410 to provide the game controller 410 with a floating, weightless feel during use. Such a stand for the controller is similar to a tripod for a camera but has movement and a spring 420, so that the support of the stand is almost not felt, but rather, provides the impression that the controller 410 has become very light.

Therefore, the detachable stand 400 includes a spring 420 (providing a lifelike floating feeling), a swivel (for natural movement) and an add-on spine 430 including modular building blocks 430a, thus making the stand 400 height adjustable. The stand 400 can include a swiveling and detachable head 440 that snaps onto a bottom portion of the skin on the controller 410, and that snaps on and off for variable height. As noted above, a spring 420 is provided for cushioning and natural suspension. Additionally, in the present embodiment, a rocker platform 450, made from, for example, foam and rubber, permits the controller to rock for more comfortable playing.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A device for enhancing operation of a game controller including at least one actuable element, the device comprising:
a skin configured to overlay at least a portion of the game controller;
at least one actuator supported by said skin with a first end disposed over the at least one actuable element and a second end distal from said first end; and
said at least one actuator arranged on the skin such that actuation of said second end in a first direction causes said first end to engage and actuate the at least one actuable element.

2. The device of claim 1, wherein said second end is connected to a motorized actuator for actuating the controller in response to stimuli on the controller.

3. The device of claim 2, wherein the stimuli is provided by a motion sensor provided with said skin.

4. The device of claim 1, wherein said second end is a free end overhanging at least one of a circumferential edge of said skin or a circumferential edge of the game controller, said free end being actuable by a part of a user's hand other than a thumb of the user when the game controller is held by the user.

5. The device of claim 1, including at least one thumb control disposed on the face of the game controller for actuation by a thumb of the user, the second end being arranged to be actuable by a part of the user's same hand other than the thumb while the thumb is simultaneously engaged with the at least one thumb control.

6. The device of claim 1, wherein the at least one actuable element is located on the top face of the game controller.

7. The device of claim 1, wherein the at least one actuable element is located on an end face of the game controller.

8. The device of claim 7, wherein the at least one actuator is actuated by squeezing at least a portion of the skin.

9. The device of claim 1, wherein the at least one actuator is customizable by plastically deforming the actuator to fit the hand of a particular user.

10. The device of claim 1, wherein the at least one actuator includes a lever pivotally supported on said skin by a hinge.

11. The device of claim 1, including a plurality of actuators supported by said skin, each of said plurality of actuators having a first end disposed over one of a plurality of actuable elements of the game controller and a second end distal from said first end.

12. The device of claim 1, wherein each said second end is a free end overhanging at least one of the circumferential edge of said skin or the circumferential edge of the game controller, said free end being actuable by a part of a user's hand other than a thumb of the user when the game controller is held by the user.

13. An accessory for enhancing operation of a game controller including at least one actuable element, the accessory comprising:
a skin configured to overlay at least a portion of the game controller, the skin including a top housing and a housing bottom, said top housing engaging said bottom housing to maintain the game controller therebetween;
at least one actuator mounted to said skin proximal to the at least one actuable element;
said at least one actuator configured such that actuation of a first part of the actuator causes a second part of the actuator to engage and actuate the at least one actuable element.

14. The accessory of claim 13 wherein at least said top housing is formed of a substantially rigid molded plastic.

15. The accessory of claim 13, wherein the top housing including a plurality of openings therethrough for providing access to at least one actuable element located on a top face of the game controller when the top housing overlays the top face of the game controller.

16. The accessory of claim 13, wherein the actuator is located proximal to, and actuates, an actuable element located on an end face of the game controller.

17. The accessory of claim 16, wherein the actuator is actuated by pressing a portion of the housing bottom towards the top housing.

18. The accessory of claim 13, wherein said at least one actuator is mounted to the skin by a hinge, wherein said actuator is pivotable relative to said hinge.

19. The accessory of claim 13, wherein said actuator is a motorized actuator.

20. A method for using an accessory for enhancing operation of a game controller including at least one actuable element, the method comprising:
providing an accessory according to claim 13;
enclosing the game controller within the skin of the accessory such that the outer housing of the top face of the controller underlies the top housing of the skin and the actuator is disposed proximal to the at least one actuable element; and
actuating the at least one actuable element with the actuator.
